(19) United States
(12) Patent Application Publication
(10) Pub. No.: US 2008/0208758 A1
(43) Pub. Date: Aug. 28, 2008

(54) METHOD AND APPARATUS FOR SECURE TRANSACTIONS

(76) Inventors: Norman S. Spiker, Phoenix, AZ (US); Paul M. Walters, Scottsdale, AZ (US)

Correspondence Address: WALLACE, LLC, P.O. BOX 1925, PAYSON, AZ, 85547, US

(21) Appl. No.: 12/113,852

(22) Filed: May 1, 2008

Related U.S. Application Data
(60) Provisional application No. 61/033,220, filed on Mar. 3, 2008.

(51) Int. Cl. G06Q 40/00; H04L 9/10

(52) U.S. Cl. 705/70; 705/71; 705/73; 705/50

(57) ABSTRACT

A method and apparatus is provided for secure terminals that facilitate secure data transmission and are compliant with the payment card industry (PCI) data security requirements. A security processor is combined with an application processor and a display into a secure display control unit (SDCU) that provides tamper resistance and other security measures. Modular secure I/O devices are interfaced to the SDCU via a wired, or wireless, medium so as to facilitate secure data transfer to the SDCU during a point-of-sale (POS) transaction or other transaction that requires secure data entry. The secure I/O devices implement one-time-pad (OTP) encryption, where the random keys, or pads, are generated by a derived unique key per transaction (DUKPT) generator. Other embodiments facilitate interconnection of the secure I/O devices to a hardware security module (HSM) or a personal computer (PC) while maintaining a high level of data security.

### FIELD OF THE INVENTION

The present invention generally relates to electronic transactions, and more particularly to secure electronic transactions.

### BACKGROUND OF THE INVENTION

With the advent of signature based payment media, such as credit cards and signature based debit cards, the ability to electronically authorize and settle transactions has virtually eliminated the need for cash. In particular, the customer's banking information may be derived from the magnetic stripe of the credit card using a magnetic stripe/swipe reader (MSR) or other means such as radio frequency identification (RFID). The necessary authorization and settlement functions may then be electronically executed to complete the customer's purchase. Authentication of the credit/debit card holder may be verified by the merchant through comparison of the customer's signature on the back of the credit card to the signature on the merchant's receipt. Such a signature not only authenticates the credit card holder, but also indicates the credit card holder's consent to repay the credit card issuer for the amount charged.

Bank card associations, however, require the merchant to pay interchange fees to the banks that issue the credit cards. Interchange fees may range, for example, between 1 and 6 percent for each transaction depending upon the merchant. In addition, interchange fees may vary from card to card, where business credit cards and rewards cards often require higher interchange fees. Even higher interchange rates may be charged when merchants pursue verbal authorizations over the telephone, or electronic authorizations using the Internet, for card/cardholder not present (CNP) transactions.

PIN-based debit cards, therefore, are becoming increasingly popular with merchants of all types, since PIN-based interchange fees are generally less than signature-based interchange fees. Merchants operating with slim profit margins are especially interested in PIN-based debit card transactions because signature based interchange fees consume a large portion of the already low profit. PIN-based debit cards are also becoming an increasingly popular method of payment for unattended, or semi-unattended, point-of-sale (POS) terminals, such as may be found at gasoline pumps, kiosks, automatic teller machines (ATMs), etc.

By including a PIN entry device at a POS terminal, the identity of the cardholder may be ascertained without intervention of the merchant. However, the security of the PIN is subject to strict controls as promulgated by the payment card industry (PCI) data security standard (DSS) and PCI pin entry device (PED) compliance. POS terminals that are PCI compliant must meet strict security standards that, among other requirements, are designed to substantially reduce the ability to compromise the PINs for unauthorized use through an attack on the POS terminal.

As such, a vulnerability measure, i.e., attack potential value, is assigned to the POS terminal, which quantifies the ability to identify and exploit the vulnerabilities of the POS terminal during the identity and exploitation phases of the attack. The identification phase includes the effort that is required to mount the attack along with a demonstration that the attack may be successfully applied to the POS terminal. The exploitation phase corresponds to the implementation of the attack as defined by the identification phase. In both the exploitation and implementation phases, the attack potential value is derived from an analysis of various relevant factors, such as elapsed time of the exploitation/identification phases, expertise of the attacker, equipment needed to exploit/implement the attack, etc.

Turning to FIG. 1, a conventional PED is illustrated as an integration of various components whose attack potential value is approved for use as an attended PED. Tamper resistance and evidence, for example, is provided by enclosure 102, thus providing a first measure of attack potential compliance to reduce the threat of physical attack against the PED. Further, individual components, such as pin pad 114, security processor 112, and optional card reader 118 each contribute attack potential values that further enhance the security of the PED.

In operation, the PED allows a card holder to enter account information using optional card reader 118 during a particular transaction. The requisite information may then be derived from the credit/debit card to generate a credit/debit request to effect either an electronic funds transfer directly from the card holder's bank account, or the card holder's line of credit, to settle the transaction via payment network 116. Card reader 118 is an optional device for the PED and may implement any one of a number of contact-based technologies, such as a magnetic stripe/swipe reader (MSR) or smartcard reader. Conversely, card reader 118 may implement any one of a number of contactless technologies, such as radio frequency identification (RFID).

In the case of a signature based debit transaction, the credit request is transmitted to payment network 116 via application processor 106. In such an instance, payment network 116 represents a credit network operated by one of the credit card brands, such as Visa® Inc. or MasterCard® Worldwide. The credit network may then query the card holder for additional information, such as the card holder's zip code, to authenticate the card holder. The query is processed by application processor 106/security processor 112 and is provided to display 104 to prompt the card holder to enter the requisite information via pin pad 114. In such an instance, security processor 112 must transition to a clear text mode, so that the zip code entered via pin pad 114 may be delivered to payment network 116 via application processor 106 in a format that may be perceived by the credit network, i.e., a non-encrypted format.

In the case of a PIN-based debit transaction, the debit request is transmitted to payment network 116 via application processor 106, where payment network 116 may represent, e.g., the electronic funds transfer point of sale (EFTPOS) network. The card holder is then prompted for a PIN, which when entered via pin pad 114, is subsequently encrypted by security processor 112 and transmitted to payment network 116 via application processor 106. The debit request is then authorized by the card holder's bank upon verification of funds and upon verification that the PIN entered by the card holder correlates to the debit card presented for settlement.

The PED of FIG. 1 is a fully integrated unit, which is commonly utilized in attended POS environments by, e.g., POS cash register systems and POS terminals, that are connected to payment devices. In other applications, however, the integrated PED concept may be too restrictive and cumbersome to meet market demands. In particular, designing or retrofitting an integrated PED into a kiosk or vending machine may not be possible due to functionality that is provided by the kiosk or vending machine. In such instances, the individual components of an integrated PED must be “modularized” and individually placed into locations that may accommodate the modular components, so that POS functionality may nevertheless be implemented within those applications where flexibility is desired or component placement is limited.

Modularization of an integrated PED, however, requires that one or more components of the integrated PED, e.g., card reader 118, pin pad 114, etc., be singulated from the integrated unit. That is to say, in other words, that components, such as card reader 118 and pin pad 114, must first be removed from enclosure 102 and implemented within their own respective enclosures, so as to facilitate their implementation within applications offering limited space or unique look and functionality. As discussed above, however, enclosure 102 provides tamper resistance and other security measures that contribute to the integrated PED's PCI compliance. Thus, once enclosure 102 is removed, the singulated components must be designed to individually meet the PCI security standards before they may be collectively used as PCI compliant, POS terminal components allowing plug and play installation.

A conventional solution, therefore, is to provide a security processor and appropriate tamper resistance within each modular component so as to achieve PCI compliance independently. Such solutions, however, may be cost prohibitive due to the performance that is required to be provided by each subsequent security processor, which inherently increases the cost of each modular component. In particular, conventional modular solutions utilize a security processor in each of the modular components to implement, among other functions, a public key infrastructure (PKI) arrangement.

That is to say, in other words, that each modular component of the POS terminal may utilize public key information in their respective public key certificates to encrypt messages to the other modular components of the POS terminal. Using corresponding private keys, each modular component is then able to decrypt the incoming messages that are encrypted with the receiving modular component's public key. Implementing such a public key infrastructure within each modular component of the POS terminal requires that each individual security processor be capable of performing asymmetric cryptography, which significantly increases the requisite performance of the security processors.

While such a modular approach provides secure and trusted communications between the modular components of the POS terminal, the security level obtained is generally much more robust than is required for PCI compliance. The conventional modular approach, therefore, needlessly increases cost and complexity.

Other techniques to achieve a PCI compliant implementation involves the use of an encrypting pin pad (EPP), which includes a pin pad similar to pin pad 114 of FIG. 1 and security processor 112. Such an EPP, however, must support signature-based transactions, which implies that the EPP must also support a clear text mode of communication. The EPP, for example, must support credit network queries for card holder's identifying information, such as the card holder's zip code, vehicle license number, odometer reading, etc., to authenticate the card holder.

In response, the EPP must transmit the card holder's identifying information as clear text, since the credit network does not support decryption capabilities. Thus, use of conventional EPPs to achieve a modular solution is not PCI compliant, since a spoofing attack on the EPP may cause the EPP to enter the clear text mode while the user is being queried for his or her PIN. The spoofed EPP is then caused to transmit the PIN as clear text, which may then be easily intercepted within payment network 116 to compromise the card holder's bank account.

Alternately, if the EPP and associated display are not mutually protected by a PCI compliant enclosure, a spoofing attack may allow the attacker to commandeer the display. In such an instance, software/hardware installed by the attacker may cause unauthorized prompts to appear on the display, which cause the card holder to enter personal information, such as the card holder's PIN, to compromise the card holder's banking information.

Efforts continue, therefore, to provide a solution for secure terminals that is modular, PCI compliant, and cost effective.

### SUMMARY OF THE INVENTION

To overcome limitations in the prior art, and to overcome other limitations that will become apparent upon reading and understanding the present specification, various embodiments of the present invention disclose a method and apparatus for a modular, secure terminal that secures data transmission in a cost effective manner.

In accordance with one embodiment of the invention, a secure terminal comprises a secure display control unit including a security processor that is coupled to receive cryptograms and is adapted to decrypt the cryptograms using a first set of derived one-time-pads, a first display that is coupled to the security processor, and a first enclosure to encapsulate the security processor and the display. The first enclosure provides physical security for the security processor and the display. The secure terminal further comprises at least one secure input/output device that is coupled to the secure display control unit and is adapted to provide the cryptograms to the security processor. The at least one secure input/output device derives a second set of one-time-pads, identical to the first set of one-time-pads, that are used to encrypt the cryptograms.

In accordance with another embodiment of the invention, a secure transaction processing system comprises at least one secure input/output device, where each secure input/output device includes a one-time-pad encryption engine that is coupled to receive clear data generated within the secure input/output device and is adapted to encrypt the clear data with one-time-pads from a first set of one-time-pads derived from an initial derivation key. The secure transaction processing system further comprises a device controller that is communicatively coupled to the at least one secure input/output device and is adapted to decrypt the encrypted data using one-time-pads from a second set of one-time-pads derived from the initial derivation key. The first and second set of one-time-pads are identical.

In accordance with another embodiment of the invention, a method of providing secure transactions comprises attaching a secure input/output device to a device controller, providing identification of the secure input/output device to a device authentication server in response to the attachment, issuing an initial derivation key to the device controller from the device authentication server in response to the provision of identification, deriving one-time-pad encryption keys from the initial derivation key within the secure input/output device, encrypting data generated within the secure input/output device using the one-time-pad encryption keys, deriving one-time-pad decryption keys from the initial derivation key within the device controller, and decrypting data from the secure input/output device within the device controller using the one-time-pad decryption keys.

### BRIEF DESCRIPTION OF THE DRAWINGS

Various aspects and advantages of the invention will become apparent upon review of the following detailed description and upon reference to the drawings in which:

FIG. 1 illustrates a conventional personal identification number (PIN) entry device;

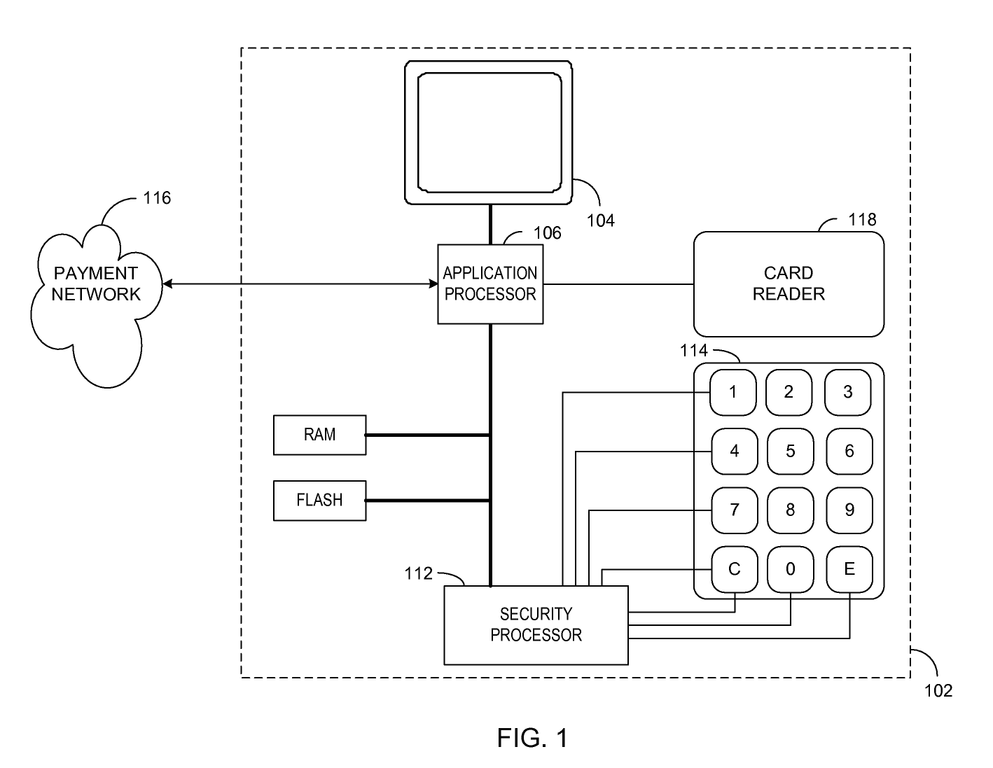

FIG. 2 illustrates a secure display control unit (SDCU) and associated secure input/output (I/O) devices securely arranged in accordance with one embodiment of the present invention;

FIG. 3 illustrates a block diagram of a one-time-pad (OTP) encryptor implemented within the secure I/O devices of FIG. 2 in accordance with one embodiment of the present invention;

FIG. 4 illustrates a flow diagram of the OTP encryption performed by the secure I/O devices of FIG. 2 in accordance with one embodiment of the present invention;

FIGS. 5A-5C exemplify various embodiments in accordance with the present invention whereby a single SDCU may be utilized to control multiple secure I/O devices and multiple displays;

FIG. 6 illustrates a block diagram in accordance with the present invention whereby a highly secure hardware security module (HSM) is utilized to control multiple secure I/O devices and multiple displays;

FIG. 7 illustrates an embodiment in accordance with the present invention whereby secure I/O devices are interfaced to a personal computer to facilitate secure data entry; and

FIG. 8 illustrates a flow diagram in accordance with the present invention whereby various secure I/O devices are utilized to facilitate plug and play secure transactions.

### DETAILED DESCRIPTION

Generally, various embodiments of the present invention are applied to a modular, secure terminal that secures data transmission and is compliant with the payment card industry (PCI) PIN entry device (PED). In a first embodiment, a security processor is combined with an application processor and a display into a secure display control unit (SDCU) that provides tamper resistance and other security measures that are PCI PED compliant and that establish the same security as a fully integrated PED. Modular secure I/O devices, such as a secure key pad (SKP) and a secure card reader (SCR), are interfaced to the SDCU via a wired, or wireless, medium so as to facilitate secure data transfer from the SKP/SCR to the SDCU during a POS transaction, or other transaction that requires secure data entry. In other embodiments, the SKP and SCR may be combined into a single modular unit.

The SKPs and SCRs do not require the same processing power as the SDCU, since the SKPs and SCRs are not required to implement asymmetric cryptographic functions as is the SDCU. Instead, microcontrollers are utilized within the SKPs and SCRs to implement one-time-pad (OTP) encryption, where the random keys, or pads, are generated by a derived unique key per transaction (DUKPT) generator. As such, the expense of the SKPs and SCRs may be significantly reduced, e.g., by at least an order of magnitude relative to conventional encrypting pin pads (EPPs), while maintaining PCI compliance.

By integrating the display with the application and security processors, the SDCU maintains PCI compliant physical security, such that the display is always in a trusted relationship with the security processor. Thus, only the security processor determines whether the display may render clear text from the application processor, or whether the payment network may receive clear text from the application processor. Since the physical security of the SDCU and the attack potential value of the secure processor is maintained to be PCI PED compliant, substantially any spoofing attack that may cause the security processor to provide PIN information, or other sensitive information, in the clear is deemed infeasible.

The secure terminal of the present invention is a modularized implementation, due in part to the implicit compatibility of the SDCU with authorized secure input/output (I/O) devices, such as an SKP or SCR, that may be communicatively coupled to the SDCU. Authentication of the secure I/O devices begins at the manufacturing stage, where the secure I/O devices are injected with a unique and random initial seed value and a serial number. The serial number is reported to the SDCU by the secure I/O device once the secure I/O device has been placed into a communicative relationship with the SDCU. Such a communicative relationship may be implemented using virtually any wired or wireless medium, such that the serial number is transferred from the secure I/O device to the SDCU.

The SDCU then reports the serial number of the secure I/O device to a device authentication server (DAS), which uses asymmetric remote key loading to distribute a cryptogram containing the initial seed value that corresponds to the serial number as reported by the secure I/O device. The SDCU then decrypts the initial seed value received from the DAS in accordance with the public key infrastructure (PKI) arrangement previously established between the SDCU and the DAS.

In one embodiment, the DAS may exist off-site relative to the SDCU, such that a network medium, e.g., the Internet, is used to deliver the cryptogram for on-line authentication. In an alternate embodiment, the DAS may be implemented as a mobile device, e.g., laptop computer, personal digital assistant (PDA), or mobile telephone, to deliver the cryptogram to the SDCU for off-line authentication, when network access to the remotely deployed DAS is not possible.

Implicit authentication of the secure I/O device results only when the initial seed value as reported by the secure I/O device matches the initial seed value that is reported by the DAS, since only then will encrypted communications between the secure I/O device and the SDCU be successfully decrypted. That is to say, in other words, that the derived encryption imposed by the secure I/O device may only be decrypted by the SDCU using a decryption key that is derived from the secure I/O device's initial seed value.

If authentication is successful, then the SDCU and the secure I/O device enter into a trusted relationship that allows encrypted communications between the secure I/O device and the SDCU. If, on the other hand, authentication is not successful, then encrypted communications from the secure I/O device cannot be decrypted by the SDCU, thus preventing formation of the trusted relationship between the secure I/O device and the SDCU.

As discussed above and in more detail below, DUKPT key management between the secure I/O device(s) and the SDCU is utilized to generate keys for the OTP buffer. Using the DUKPT method of key management, a new OTP is generated by the secure I/O device for each transaction. In particular, a new key is derived by the secure I/O device based upon elements in the previous transaction and an initial derivation key (IDK). In addition, once a key has been used to encrypt a data element, or other sensitive information, the key is then destroyed by the secure I/O device, so as to prevent storage of previously utilized keys within the secure I/O device.

In other embodiments, a single SDCU may be utilized to provide content to two or more displays simultaneously, while at the same time, communicating with secure I/O devices that correspond to the two or more displays. Such an implementation is useful when multiple payment devices are required, such as multiple POS terminals to service multiple gasoline pump stations, multiple ticketing kiosks, clustered vending machines, etc.

In an alternate embodiment, a hardware security module (HSM) is utilized instead of the SDCU, whereby the HSM may be coupled via wired, or wireless, means to a plurality of secure I/O devices, such as a plurality of SKPs and SCRs. Such an implementation is useful, for example, in supermarkets where multiple lanes are available for checkout. In such an instance, each checkout lane is equipped with one or more secure I/O devices that are communicatively coupled to a co-located HSM. The HSM authenticates each secure I/O device of each checkout lane via asymmetric remote key loading from the associated DAS. Once authenticated, the HSM utilizes OTP encrypted cryptograms from the authenticated secure I/O devices to ultimately authorize and settle transactions conducted at each checkout lane.

In yet another embodiment, the HSM may be remotely located relative to one or more secure I/O devices, where the HSM is communicatively coupled to the one or more secure I/O devices via a network medium such as the Internet. The HSM authenticates each secure I/O device via asymmetric remote key loading from the associated DAS. In such an instance, each secure I/O device becomes a means for secure data entry in support of, e.g., PIN-based transactions, secure login sessions, etc. Such an implementation, for example, allows a personal computer (PC) equipped with a compatible interface, such as a universal serial bus (USB), to be used for PIN-based commerce, among other transactions, over the Internet without the threat of key loggers, spyware, etc., recording data from the secure I/O device.

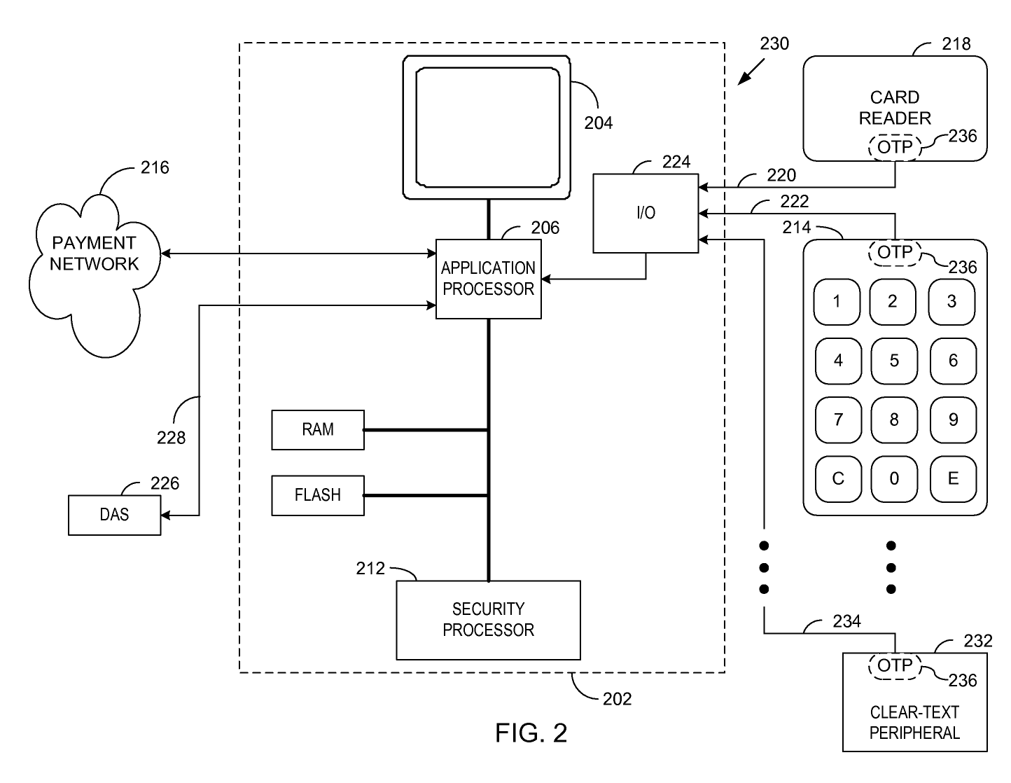

Turning to FIG. 2, modular components of a secure terminal in accordance with one embodiment of the present invention are exemplified. SDCU 230 includes security processor 212, application processor 206, random access memory (RAM), and associated read-only memory, such as FLASH or EEPROM, for storing computational instructions that are executable by processors 212 and 206. Such computational instructions, for example, enable application processor 206 to provide text-based and/or graphics-based content to display 204, receive data from I/O 224, interact with security processor 212, and interoperate with payment network 216. SDCU 230 further includes enclosure 202, which encapsulates the individual components of SDCU 230 to provide sufficient physical security so as to maintain PCI compliance.

Secure card reader (SCR) 218 is an additional modular component of the secure terminal of FIG. 2 and is an optional device that may implement any one of a number of contact-based technologies, such as a magnetic stripe/swipe reader (MSR) or smartcard reader. Conversely, SCR 218 may utilize any one of a number of contactless technologies such as radio frequency identification (RFID). As discussed in more detail below, SCR 218 ultimately provides OTP encrypted data to security processor 212 via wire, or wireless, medium 220 as generated by OTP encryptor 236. Since a calculation intensive cryptographic arrangement, such as the public key infrastructure (PKI), is not implemented within SCR 218, a significantly less costly security processing engine may instead be implemented within SCR 218 while maintaining PCI PED compliance of SCR 218.

Secure key pad (SKP) 214 is an additional modular component of the secure terminal of FIG. 2, which incorporates identical OTP encryptor 236 as implemented within SCR 218. Accordingly, a significantly less costly security processing engine, as compared to a PKI arrangement, may be implemented within SKP 214 while maintaining PCI compliance of SKP 214. In one embodiment, SKP 214 and SCR 218 may be combined into a single modular component, depending upon the requirements of the particular application in which SKP 214 and SCR 218 are being utilized.

One or more other clear-text peripherals 232, such as a magnetic ink character recognition (MICR) device, keyboard, etc., may also be accommodated as additional modular components of the secure terminal of FIG. 2. Other clear-text peripherals 232 also include OTP encryptor 236 to provide OTP encrypted data to security processor 212 via wire, or wireless, medium 234. Generally speaking, any clear-text peripheral may be designed, or retrofitted, to include OTP encryptor 236 so as to facilitate the compatibility of clear-text peripherals 232 as additional modular components of the secure terminal of FIG. 2.

SKP 214, SCR 218, and other clear-text peripherals 232 are implicitly compatible with SDCU 230 once successful authentication is completed. Authentication of SKP 214, SCR 218, and other clear-text peripherals 232 begins by establishing a communicative relationship between SKP 214, SCR 218, other clear-text peripherals 232 and I/O block 224, where the communication link may be established wirelessly, e.g., via Wi-Fi, or through a wired connection such as USB, RS232, Ethernet, etc. Once established, communication links 220, 222, and 234 are utilized to transmit the serial number associated with SKP 214, SCR 218, and other clear-text peripherals 232, respectively, to application processor 206 via I/O block 224.

Application processor 206 then reports the serial number received from SKP 214, SCR 218, and other clear-text peripherals 232 via communication link 228, which may also be established as a wired, or wireless, communication link. In response, DAS 226 deposits the initial seed value that corresponds to the serial number as reported by SKP 214, SCR 218, and other clear-text peripherals 232 using asymmetric remote key loading in accordance with the public key infrastructure (PKI) arrangement previously established between SDCU 230 and DAS 226.

Authentication of SKP 214, SCR 218, and other clear-text peripherals 232 results only when their respective initial seed values match the initial seed value that is reported by DAS 226, since only then will encrypted communications between SKP 214, SCR 218, other clear-text peripherals 232 and security processor 212 be successfully decrypted. That is to say, in other words, that the OTP encryption imposed by SKP 214, SCR 218, and other clear-text peripherals 232 may only be decrypted by security processor 212 using initial seed values that are unique to SKP 214, SCR 218, and other clear-text peripherals 232. As such, the initial seed values become the initial derivation keys (IDKs) of the OTP encryption algorithm. The IDKs are then used to derive the chain of keys used for future encryption of the cryptograms that are to be exchanged between SKP 214, SCR 218, other clear-text peripherals 232, and security processor 212.

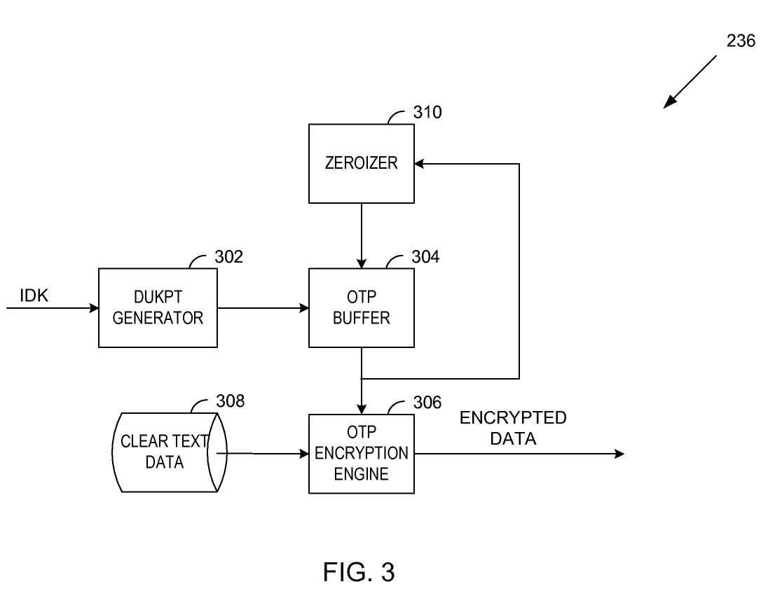

Turning to FIG. 3, an exemplary block diagram of OTP encryptor 236 in accordance with one embodiment of the present invention is exemplified. OTP encryptor 236 may be implemented within each of SKP 214, SCR 218, and other clear-text peripherals 232, hereinafter referred to as secure I/O devices, whereby the associated encryption hardware/software is physically secured within the enclosures of the secure I/O devices to remain PCI compliant.

The initial seed values, i.e., IDKs, and serial numbers that are injected into the secure I/O devices during manufacture are also known by, e.g., DAS 226 of FIG. 2. Through asymmetric remote key loading, security processor 212 is apprised of the respective IDKs that are pre-loaded into each secure I/O device that is connected to SDCU 230 through execution of the authentication process as discussed above. As such, the IDK of FIG. 3 is the shared secret between security processor 212 and one of the secure I/O devices that has been authenticated to security processor 212.

It is noted, that DUKPT generator 302 exists within each secure I/O device as well as within security processor 212. As such, while DUKPT generator 302 of the secure I/O device derives keys, or pads, that are used for OTP encryption via OTP encryption engine 306, DUKPT generator 302 also exists within security processor 212 to derive the matching keys, or pads, that are used for OTP decryption. Once a set of keys, or pads, have been used to encrypt/decrypt a data exchange between the secure I/O device and security processor 212, a new set of keys, or pads, are then utilized to encrypt/decrypt the next data exchange between the secure I/O device and security processor 212. Thus, the IDK value is utilized in both the secure I/O device and security processor 212 to derive the identical chain of keys that are used at each end of the encrypted communication links between security processor 212 and the respective secure I/O devices that are authenticated to security processor 212.

In one embodiment, DUKPT generator 302 supports the triple data encryption standard (TDES) in derivation of the OTPs that are stored within OTP buffer 304. Thus, the key length of each OTP is equal to 128 bits, which in one embodiment, is capable of encrypting 16 bytes of data, or equivalently, 16 key presses of SKP 214. It can be seen, therefore, that by utilizing a DUKPT register of sufficient length, the number of OTPs that may be derived by DUKPT generator 302 far exceeds the lifetime of the secure I/O device that is generating clear-text data 308, since a typical SKP, for example, remains operational for only, e.g., 1-2 million key strokes.

The depth of OTP buffer 304 may be set to accommodate any number of future OTPs as may be required by a particular application. For example, if key press data is provided to OTP encryption engine 306, then a single OTP is adequate to encrypt, e.g., four 4-digit PINs. As such, the depth of OTP buffer 304 may be relatively shallow, since relatively few OTPs may be required over a given time period of pin pad activity. If, on the other hand, card data or MICR data is provided to OTP encryption engine 306, then a single card swipe or check reading event may require many more OTPs, since many more data bytes may be received from a typical card/check reader event. As such, the depth of OTP buffer 304 may be relatively deep, since relatively many OTPs may be required over a given time period of card/check reader activity.

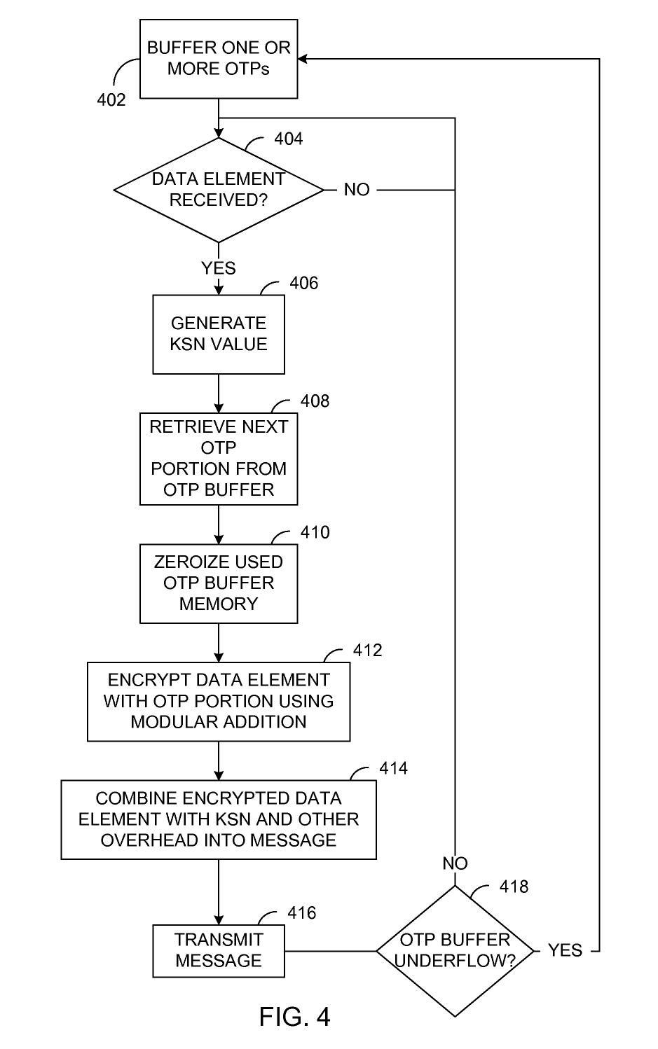

Turning to FIG. 4 and Table 1, an OTP encryption method, as may be executed by OTP encryptor 236 is exemplified. In step 402, one or more OTPs are generated by DUKPT generator 302 and stored within OTP buffer 304 for future use. OTP buffer write and read pointers are initialized and incremented, such that the OTP write pointer is capable of addressing, e.g., 16-byte blocks, within OTP buffer 304, whereas the OTP read pointer is capable of addressing, e.g., each 1-byte segment of each 16-byte block within OTP buffer 304.

As discussed above, the number of OTPs generated and buffered in step 402 is determined in part by the secure I/O device that is being utilized. If an SCR is utilized, for example, then perhaps an increased number of OTPs may be generated and buffered. If, on the other hand, an SKP is utilized, then perhaps a decreased number of OTPs may be generated and buffered. Thus, the number of OTPs buffered within OTP buffer 304 may be controlled by appropriate read and write pointer management so as to prevent an underflow, or overflow, condition within OTP buffer 304.

In step 404, a determination is made as to whether a data element is received. It is noted that key press data, card data, MICR data, keyboard data, or other clear-text data types may be received depending upon the secure I/O device that is being utilized. The encryption method is identical no matter which type of secure I/O device is communicatively coupled to the SDCU, therefore, key press data from an SKP is hereinafter implied. In other words, all data is hereinafter implied to be provided by an SKP and encrypted using OTP encryptor 236 of FIG. 3.

If a data element has been received, then the first portion of the first OTP is retrieved from OTP buffer 304 via the OTP read pointer in step 408, whereby the initial value of the OTP read pointer is equal to 0 and is incremented in accordance with the amount of data retrieved. In one embodiment, for example, 2 bytes of data are retrieved from OTP buffer 304 in order to encrypt a single data element 308, therefore, the read pointer is also incremented by 2. Prior to incrementing the OTP read pointer, the first nibble of the DUKPT key serial number, KSN, is set equal to the OTP read pointer in step 406, so as to provide indexing information as to which byte of which OTP was used to encrypt the current key press. In addition, once the first and second bytes of the first OTP have been retrieved from OTP buffer 304, zeroizer 310 nulls the first and second bytes of the OTP in step 410 so as to prevent the storage of used OTPs within the secure I/O device.

TABLE 1

| | KEY | | | |
|---|---|---|---|---|
| | PRESS | | OTP BUFFER | ENCRYPTED |
| STEP | VALUE | KSN | CONTENTS | DATA |
| Initialize | | FFFF9876543210000001 | 88322BC807FD2FC3 | |
| | | | 400924E225D68E6C | |
| First | 31ₕ = “1” | 0FFF9876543210000001 | 00002BC807FD2FC3 | 8Bₕ |
| key | | | 400924E225D68E6C | |
| press | | | | |
| Second | 32ₕ = “2” | 2FFF9876543210000001 | 0000000007FD2FC3 | D1ₕ |
| key | | | 400924E225D68E6C | |
| press | | | | |
| Third | 33ₕ = “3” | 4FFF9876543210000001 | 0000000000002FC3 | C9ₕ |
| key | | | 400924E225D68E6C | |
| press | | | | |
| Fourth | 34ₕ = “4” | 6FFF9876543210000001 | 0000000000000000 | D8ₕ |
| key | | | 400924E225D68E6C | |
| press | | | | |

In step 412, OTP encryption engine 306 utilizes modular addition to encrypt the data element with the first two data bytes of the OTP, wherein in one embodiment, the modular addition is implemented as a binary XOR function. Thus, if the first key press, as tabulated in Table 1, results in a data element representing a numeric “1”, then the ASCII equivalent is equal to 31 h. The binary XOR function is then calculated on the ASCII equivalent of the data element in accordance with equation (1), to determine the encrypted key press data value:

ENCRYPTED DATA=31ₕ [symbol] 88ₕ [symbol] 32ₕ=8Bₕ, (1)

where 88ₕ and 32ₕ represent the first two bytes of the OTP that are used for OTP encryption as tabulated in Table 1. The encrypted key press data value may then be combined with the KSN value generated in step 406 using, e.g., a binary OR function, to generate the message data in step 414 that is to be transmitted in step 416 to the SDCU from the secure I/O device. Other information, such as message length, message type, message format version, etc., may also be prepended as header information to facilitate communication between the secure I/O device and the SDCU.

It is noted, that the encryption protocol, as discussed above in relation to Table 1, is merely representative of the numerous encryption protocols that may be implemented by encryptor 236. For example, security processor 212 of SDCU 230 may provide a feedback mechanism to further authenticate the secure I/O devices that are connected to SDCU 230.

In one embodiment, the feedback mechanism may include the provisioning of a session token that is transmitted from security processor 212 to the secure I/O device before or during a particular secure transaction. The session token is then combined with the OTP and the data element to calculate the encrypted key press data to be sent from the secure I/O device to SDCU 230. The encrypted key press data is then decrypted by security processor 212 using the same session token and OTP. Authentication of the secure I/O device persists only when successful decryption using the session token continues. Additional session tokens may be similarly issued for subsequent transactions, so as to prevent malicious or fraudulent transactions conducted via, e.g., a replay or masquerade attack.

If the OTPs buffered in step 402 are nearing depletion, as determined in step 418 by comparison of the OTP buffer write and read pointers, then additional OTPs may be derived and buffered as in step 402. Otherwise, step 404 is executed until the next data element is received. Steps 404 through 418 are then executed to generate KSN and encrypted key press values as tabulated in Table 1 for an exemplary key press sequence of “1”, “2”, “3”, “4”.

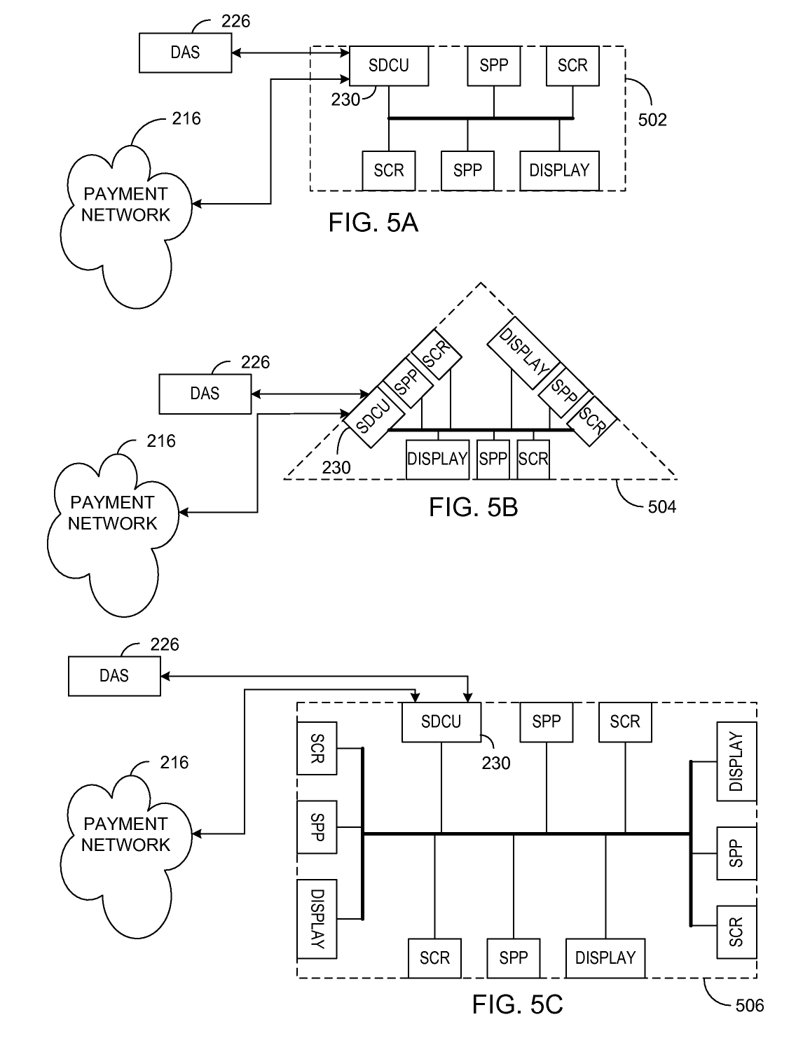

Turning to FIGS. 5A-5C, a single SDCU may be utilized to provide content to two or more displays simultaneously, while at the same time, exchange OTP encrypted cryptograms with secure I/O devices that correspond to the two or more displays. Such implementations are useful when multiple payment terminals are required, such as multiple POS terminals to service multiple gasoline pump stations, multiple ticketing kiosks, clustered vending machines, etc.

FIGS. 5A-5C exemplify two-, three-, and four-sided enclosures 502-504, respectively, whereby a single SDCU 230 is utilized to interact with at least one other display and associated secure I/O device(s) to authorize and settle PIN-based transactions with payment network 216. In each embodiment, SDCU 230 authenticates each respective secure I/O device via asymmetric remote key loading from DAS 226 as discussed above. Since the interconnect between SDCU 230 and associated secure I/O devices and displays are protected by enclosures 502-504, inherent SCI compliance is realized. It is noted that DAS 226 may either be co-located, or remotely located, with respect to the associated payment terminals of FIGS. 5A-5C, where communications between DAS 226 and the respective payment terminal(s) may be facilitated via a wired, or wireless, medium.

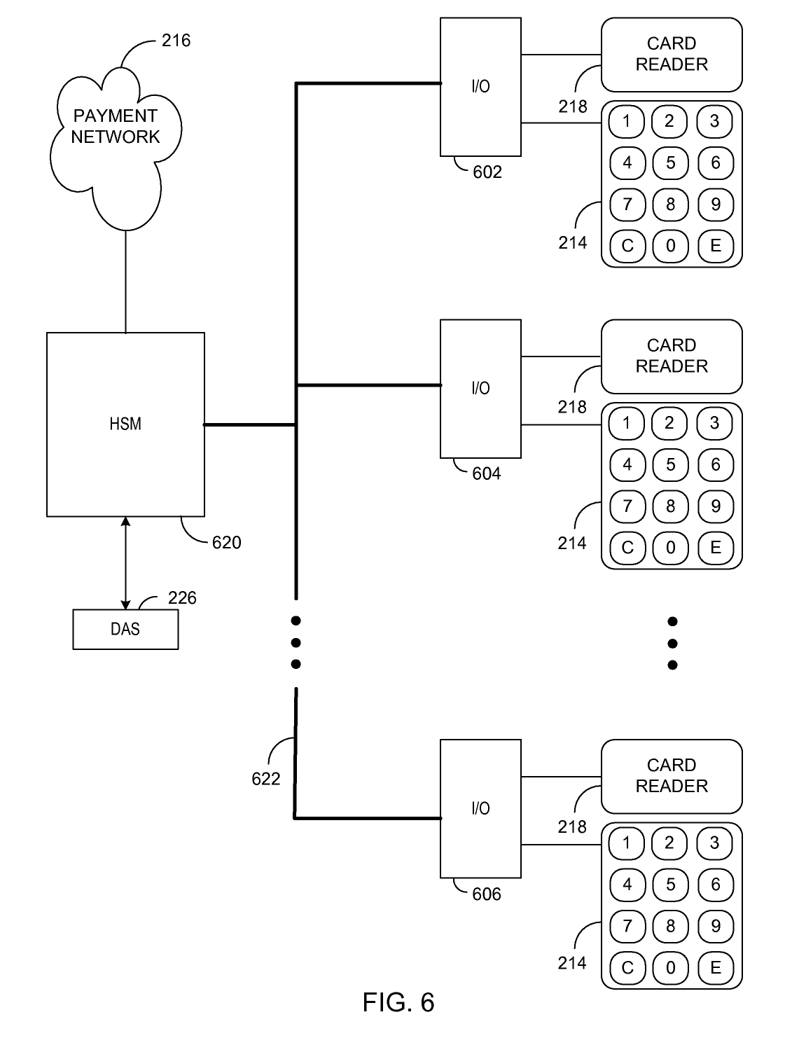

Turning to FIG. 6, hardware security module (HSM) 620 is utilized instead of an SDCU, whereby HSM 620 may be coupled via wired, or wireless, interface 622 to a plurality of secure I/O devices via I/O interface blocks 602-606. HSM 620 performs similar functions as those discussed above for SDCU 230, except that HSM 620 implements enhanced processing capability to accommodate many more cryptographic communication links. Additionally, HSM 620 may also render textual and graphic content to displays (not shown) as may be required to support transactions that are associated with the use of SKPs 214 and SCRs 218. Security of the display content is not a concern because clear text data is never exposed outside of the payment application within HSM 620.

HSM 620 authenticates each secure I/O device via asymmetric remote key loading from associated DAS 226, whereby the IDK associated with a secure I/O device is reported to HSM 620 via DAS 226 once the secure I/O device reports its associated serial number to HSM 620. As such, HSM 620 is tasked with the storage of all shared secrets, e.g., IDKs, for each secure I/O device that is communicatively coupled to HSM 620, so that HSM 620 may derive decrypting OTPs relative to each IDK held in storage. Once the secure I/O devices are authenticated, HSM 620 exchanges OTP encrypted cryptograms with the authenticated secure I/O devices, in order to authorize and settle PIN-based transactions via payment network 216.

The implementation as exemplified in FIG. 6 is useful, for example, in supermarkets where multiple lanes are available for checkout. In such an instance, each checkout lane is equipped with one or more secure I/O devices, e.g., SCR 218, SKP 214, and MICR check readers (not shown), that are communicatively coupled to HSM 620. Since SCRs 218, SKPs 214, and MICR check readers (not shown) are implemented with OTP encryption capability, as discussed above in relation to FIG. 3, OTP encrypted cryptograms may be exchanged with HSM 620 so as to provide secure communication.

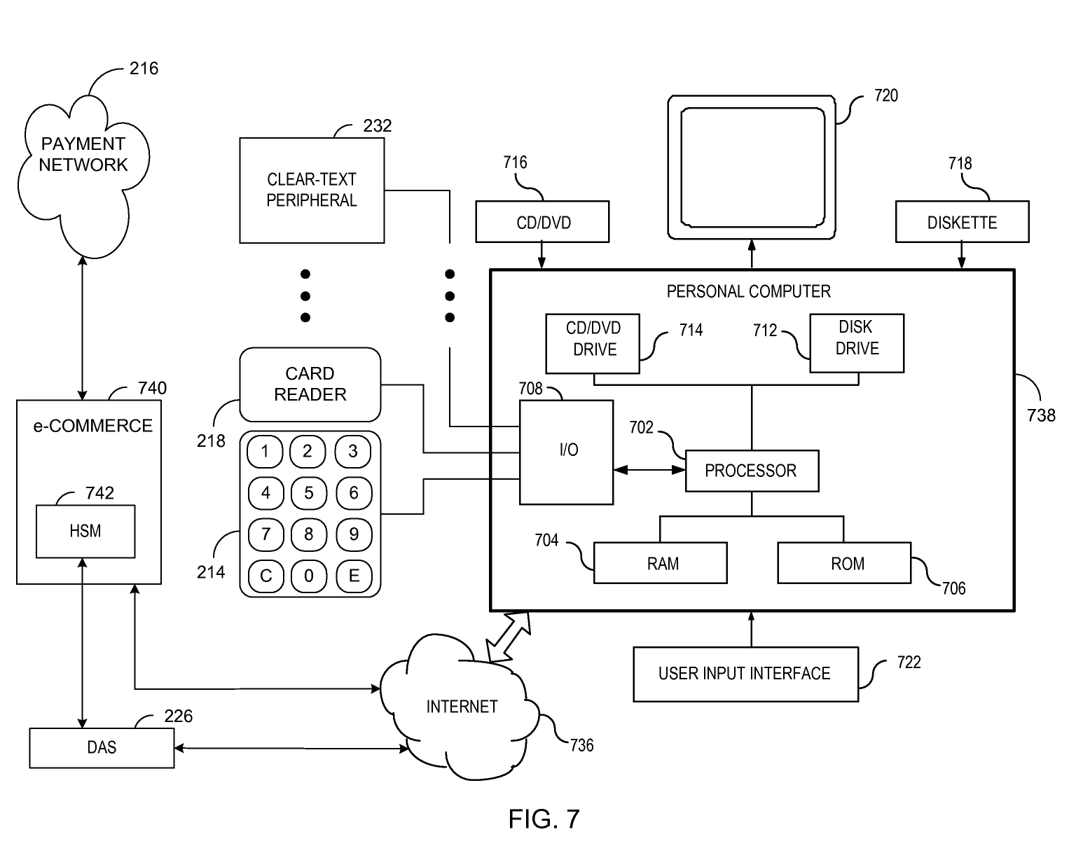

Turning to FIG. 7, a personal computing platform is illustrated, which may be used to facilitate secure data entry in accordance with one embodiment of the present invention. Personal computer 738 includes a central processor (CPU) 702 that is coupled to random access memory (RAM) 704 and read-only memory (ROM) 706. The ROM 706 may also include other types of storage media, such as programmable ROM (PROM), electronically erasable PROM (EEPROM), etc., to store executable programs and utilities. The processor 702 may also communicate with other internal and external components through input/output (I/O) device 708.

Personal computer 738 may also include one or more data storage devices, including hard and floppy disk drives 712, CD/DVD drives 714, and other hardware capable of reading and/or storing information. Personal computer 738 is coupled to a display 720, which may be any type of known display or presentation screen, such as LCD displays, plasma display, cathode ray tubes (CRT), etc. A user input interface 722 is provided, which includes one or more user interface mechanisms such as a mouse, keyboard, microphone, touch pad, touch screen, voice-recognition system, etc.

In operation, HSM 742 is remotely located relative to one or more secure I/O devices, such as SCR 218, SKP 214, and other clear-text peripherals 232, such as MICR devices and keyboards. The secure I/O devices communicate with personal computer 738 via one of a number of interface standards, such as USB, RS232, Ethernet, WiFi, etc., as may be supported by I/O device 708. HSM 742 is communicatively coupled to the one or more secure I/O devices via a network medium, such as Internet 736, and is operated by e-commerce based business 740, such as PayPal®, which allows payments and money transfers to be made through Internet 736 to payment network 216.

HSM 742 authenticates each secure I/O device via asymmetric remote key loading from associated DAS 226 once the secure I/O devices establish communication with I/O device 708. In such an instance, secure I/O devices 214, 218, and 232 become a means for secure data entry in support of, e.g., PIN-based transactions, whereby OTP encrypted cryptograms may be transmitted to e-commerce business 740 to authorize and settle purchases with payment network 216. It is further understood that SKP 214 and clear-text peripherals 232 may facilitate other transactions that require secure data entry, such as a secure login session, secure instant messaging, etc.

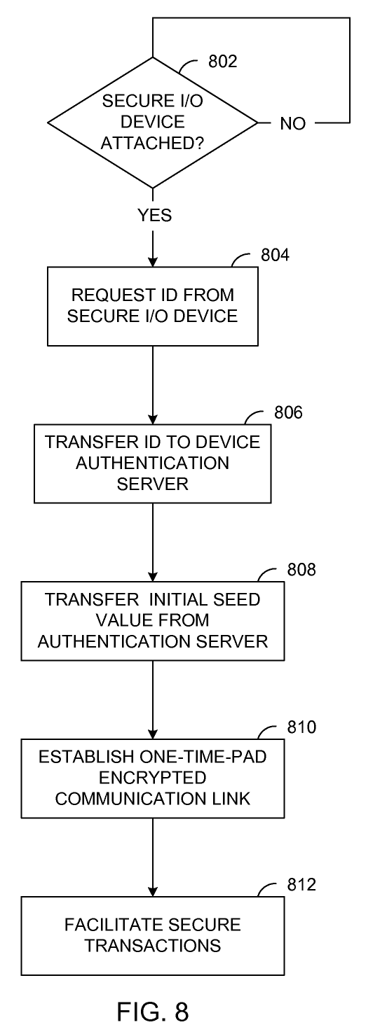

As discussed herein, various embodiments of the present invention provide a method and apparatus that promotes plug and play operation of various secure I/O devices to facilitate secure transactions as exemplified by the flow diagram of FIG. 8. In step 802, attachment of a secure I/O device is detected by a device controller, such as an SDCU, as discussed above in relation to FIGS. 2 and 5, or an HSM, as discussed above in relation to FIGS. 6 and 7. Once detected, identifying information concerning the secure I/O device, such as the secure I/O device's serial number, is requested by either the SDCU or HSM as in step 804.

The secure I/O device then transmits the identifying information to the requesting SDCU or HSM as in step 806. In response, the DAS receives an authentication request from either of the SDCU or HSM that contains the identifying information. It is noted that the DAS contains a repository of the initial seed values of all secure I/O devices that may be authenticated by the DAS. In one embodiment, the DAS then deposits the initial seed value with the SDCU or HSM, as in step 808, using asymmetric remote key loading in accordance with the public key infrastructure (PKI) arrangement previously established between the DAS and the SDCU or HSM.

Once the SDCU or HSM is apprised of the initial seed value of the secure I/O device, i.e., the IDK, OTPs are derived from the IDK using, e.g., a TDES capable, DUKPT generator in both the secure I/O device and the SDCU or HSM. If properly authenticated, the data elements encrypted by the OTPs, as derived by the secure I/O device, may be properly decrypted using the OTPs, as derived by the SDCU or HSM, to establish the OTP encrypted communication link between the secure I/O device and the SDCU or HSM as in step 810. Once established, the encrypted communication link may then be utilized to facilitate secure transactions as in step 812.

It is noted that steps 802-810 are only executed one time to authenticate the secure I/O device. However, should the secure I/O device be connected to a different SDCU or HSM, such as may be the case when the secure I/O device is transported from one PC to another as discussed above in relation to FIG. 7, the authentication procedure of steps 802-810 are then repeated.

Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A secure terminal, comprising:
a secure display control unit including,
a security processor coupled to receive cryptograms and adapted to decrypt the cryptograms using a first set of derived one-time-pads;
a first display coupled to the security processor; and
a first enclosure to encapsulate the security processor and the display, the first enclosure providing physical security for the security processor and the display; and
at least one secure input/output device coupled to the secure display control unit and adapted to provide the cryptograms to the security processor, wherein the at least one secure input/output device derives a second set of one-time-pads, identical to the first set of one-time-pads, that are used to encrypt the cryptograms.

2. The secure terminal of claim 1, further comprising an input/output block coupled to the at least one secure input/output device, the input/output block being adapted to receive the cryptograms provided by the at least one secure input/output device.

3. The secure terminal of claim 2, wherein a wired interface couples the input/output block to the at least one secure input/output device.

4. The secure terminal of claim 2, wherein a wireless interface couples the input/output block to the at least one secure input/output device.

5. The secure terminal of claim 1, wherein the at least one secure input/output device comprises:
a derived unique key per transaction generator coupled to receive an initial derivation key and adapted to derive the second set of one-time-pads from the initial derivation key; and
a one-time-pad buffer coupled to receive the second set of one-time-pads and adapted to store a programmable number of the second set of one-time-pads.

6. The secure terminal of claim 5, wherein the at least one secure input/output device further comprises:
a one-time-pad encryption engine coupled to the one-time-pad buffer, the one-time-pad encryption engine being adapted to receive one-time-pads from successive storage locations within the one-time-pad buffer and adapted to encrypt a plurality of data elements with the received one-time-pads using modular addition; and
a zeroizer coupled to the one-time-pad buffer, the zeroizer being adapted to null the successive storage locations within the one-time-pad buffer after one-time-pads from the successive storage locations are used for encryption.

7. The secure terminal of claim 6, wherein the at least one secure input/output device comprises a secure key pad.

8. The secure terminal of claim 6, wherein the at least one secure input/output device comprises a secure card reader.

9. The secure terminal of claim 6, wherein the at least one secure input/output device comprises a secure key pad combined with a secure card reader.

10. The secure terminal of claim 1, further comprising a second enclosure to encapsulate the secure display control unit and the at least one secure I/O device, wherein the second enclosure is multi-sided.

11. The secure terminal of claim 10, wherein a first side of the second enclosure contains the secure display control unit and at least one secure I/O device and the remaining sides of the second enclosure contain associated displays and associated secure I/O devices in communication with the secure display control unit.

12. A secure transaction processing system, comprising:
at least one secure input/output device, each secure input/output device including a one-time-pad encryption engine coupled to receive clear data generated within the secure input/output device and adapted to encrypt the clear data with one-time-pads from a first set of one-time-pads derived from an initial derivation key; and
a device controller communicatively coupled to the at least one secure input/output device and adapted to decrypt the encrypted data using one-time-pads from a second set of one-time-pads derived from the initial derivation key, wherein the first and second set of one-time-pads are identical.

13. The secure transaction processing system of claim 12, wherein the at least one secure input/output device further comprises:
a derived unique key per transaction generator adapted to derive the first set of one-time-pads from the initial derivation key;
a buffer coupled to receive the first set of one-time-pads and adapted to store the first set of one-time-pads for future use by the one-time-pad encryption engine; and
a zeroizer coupled to the buffer and adapted to null storage locations within the buffer that contain one-time-pads previously used by the one-time-pad encryption engine to encrypt the clear data.

14. The secure transaction processing system of claim 13, further comprising an input/output block coupled to the at least one secure input/output device, the input/output block facilitating communication between the at least one secure input/output device and the device controller.

15. The secure transaction processing system of claim 14, wherein the input/output block is contained within a personal computer.

16. The secure transaction processing system of claim 14, wherein the device controller includes a hardware security module remotely located relative to the at least one secure input/output device.

17. The secure transaction processing system of claim 16, further comprising a device authentication server coupled to the hardware security module, the device authentication server adapted to provide the initial derivation key to the hardware security module in response to the communicative coupling between the at least one security input/output device and the hardware security module.

18. A method of providing secure transactions, comprising:
attaching a secure input/output device to a device controller;
providing identification of the secure input/output device to a device authentication server in response to the attachment;
issuing an initial derivation key to the device controller from the device authentication server in response to the provision of identification;
deriving one-time-pad encryption keys from the initial derivation key within the secure input/output device;
encrypting data generated within the secure input/output device using the one-time-pad encryption keys;
deriving one-time-pad decryption keys from the initial derivation key within the device controller; and
decrypting data from the secure input/output device within the device controller using the one-time-pad decryption keys.

19. The method of claim 18, wherein deriving one-time-pad encryption keys comprises deriving one-time-pad encryption keys using a triple data encryption derived unique key per transaction generator.

20. The method of claim 19, wherein deriving one-time-pad decryption keys comprises deriving one-time-pad decryption keys using a triple data encryption derived unique key per transaction generator.
